(19) United States
(12) Patent Application Publication
(10) Pub. No.: US 2014/0227991 A1
(43) Pub. Date: Aug. 14, 2014

(54) METHOD AND SYSTEM FOR LOCATION-BASED NOTIFICATIONS RELATING TO AN EMERGENCY EVENT

(71) Applicants: Michael S. Breton, Folsom, CA (US); Wayne M. Bush, Apache Junction, AZ (US); David W. Stone, Folsom, CA (US); Jeffrey C. Sedayao, San Jose, CA (US); Cynthia K. Pickering, Phoenix, AZ (US)

(72) Inventors: Michael S. Breton, Folsom, CA (US); Wayne M. Bush, Apache Junction, AZ (US); David W. Stone, Folsom, CA (US); Jeffrey C. Sedayao, San Jose, CA (US); Cynthia K. Pickering, Phoenix, AZ (US)

(21) Appl. No.: 13/997,742

(22) PCT Filed: Mar. 31, 2012
(86) PCT No.: PCT/US12/31750

§ 371 Date: Apr. 18, 2014

(51) Int. Cl. H04W 4/22; H04W 4/04

(52) U.S. Cl. CPC H04W 4/22; H04W 4/046
USPC 455/404.2

(57) ABSTRACT

A method and system for notifying one or more non-emergency vehicle computing devices of an emergency event includes processing information about the emergency event received from an emergency vehicle computing device, comparing the location of the emergency vehicle to the location of the non-emergency vehicle, and sending a notification of the emergency event to the non-emergency vehicle computing devices based on the comparison.

### BACKGROUND

Computing devices can be an almost constant companion in our daily lives, whether as smaller form factor devices such as smartphones, tablets, portable media players, or the like, or incorporated into more traditional products such as in-vehicle information and entertainment systems, televisions, and others. It is not uncommon to see people walking, jogging, or even riding a bicycle or driving a vehicle and using a computing device (such as a smartphone) at the same time. In addition, many passenger vehicles are designed to reduce the amount of road/exterior noise that is audible inside the vehicle cabin. For these and other reasons, people may be intermittently distracted or simply unaware of things happening around them and may be startled by or even miss the fact that an emergency event has occurred. Even when not distracted, however, it can be difficult to tell based on flashing lights or siren alone, from which direction an emergency vehicle is approaching. Further, traffic situations may make it difficult for a driver to determine how to maneuver out of the path of an approaching emergency vehicle. Non-optimal decision-making may be an unfortunate response to these types of events.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of an emergency event notification system;

FIG. 2 is a simplified module diagram of at least one embodiment of an event subsystem for the emergency event notification system of FIG. 1;

FIG. 3 is a simplified module diagram of at least one embodiment of an event/notification subsystem for the emergency event notification system of FIG. 1;

FIG. 4 is a simplified module diagram of at least one embodiment of a notification subsystem for the emergency event notification system of FIG. 1;

FIG. 5 is a simplified data model diagram for at least one embodiment of the emergency event notification system of FIG. 1;

FIG. 6 is a simplified flow diagram of at least one embodiment of a method for handling emergency event information at a source computing device;

FIG. 7 is a simplified flow diagram of at least one embodiment of a method for notifying recipient computing devices of an emergency event; and

FIG. 8 is a simplified flow diagram of at least one embodiment of a method for handling an emergency event notification at a recipient computing device.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, in general, elements depicted with dashed lines are considered optional in at least some embodiments. However, that is not to imply that elements that are not depicted with dashed lines are required in all embodiments. To the contrary, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using machine-level instructions, C, C++, and/or other programming languages.

Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. Also, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

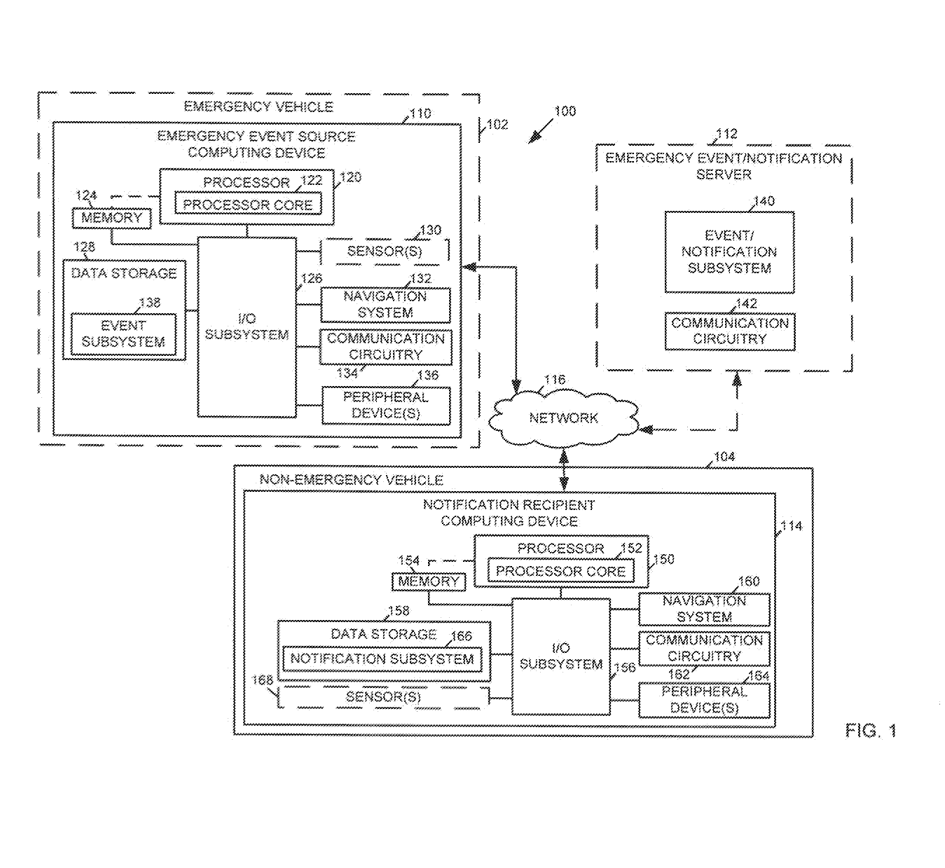

Referring now to FIG. 1, portions of an illustrative emergency event notification system 100 are embodied in a source computing device 110, a recipient computing device 114, and, in some embodiments, a server 112, which may be in communication with one another via one or more network(s) 116. In some embodiments, the source computing device 110 may be associated with an emergency vehicle 102 (such as a police car, fire truck, ambulance, or other emergency responder) while the recipient computing device 114 may be associated with a non-emergency vehicle (such as a passenger car or other motorized or non-motorized vehicle). In embodiments where the source computing device 110 is associated with the emergency vehicle 102, upon determining that the emergency vehicle 102 is in use and responding to an emergency (e.g., by detecting that the warning lights and/or siren are turned on), or that an emergency event has otherwise occurred, an event subsystem 138 illustratively embodied in the source computing device 110 generates a notification signal that can be received by the recipient computing device 114. In other embodiments, as described further below, the source computing device 110 may be a computing device configured to be carried by a person. In those embodiments, a notification signal may be generated by the source computing device 110 based on user input to the source computing device 110 (such as input indicating that the user has just witnessed an emergency event, for example).

A notification subsystem 166 illustratively embodied in the recipient computing device 114 can receive the notification signal if the recipient computing device 114 is within a vicinity of the source computing device 110. As described further below, the vicinity may be determined by comparing the location, direction of travel, speed of travel, and/or other factors relating to the emergency vehicle 102 to the location, direction of travel, speed of travel, and/or other factors relating to the non-emergency vehicle 104 and/or the recipient computing device 114. Upon receiving the notification signal, the notification subsystem 166 initiates action to notify a user of the recipient computing device 114 (e.g., the driver of the non-emergency vehicle 104) of the emergency event in a way that is, in the illustrative embodiments, difficult for the user to ignore. For example, in some embodiments, the notification subsystem 166 can mute the radio (or any other playing media) and then audibly suggest a driving maneuver intended to allow the driver of the non-emergency vehicle 104 to yield to the emergency vehicle 102. In some embodiments, the recipient computing device 114 may be mounted in the non-emergency vehicle 104 (as an in-vehicle information and/or entertainment or “infotainment” system mounted in a vehicle dashboard, for example), while in other embodiments, the recipient computing device 114 may be embodied as a mobile computing device that is typically carried by a person but which may be in communication with an in-vehicle computer system (e.g., by a wired or wireless link). Also, in some embodiments, the server 112 may facilitate the routing of emergency vehicle notifications generated by one or more source computing device(s) 110 to a number of recipient computing devices 114, and/or provide other features of the emergency event notification system 100, as described below. In this way, the system 100, and more particularly, the recipient computing device 114, can help facilitate a proper response to an approaching emergency vehicle or other emergency event.

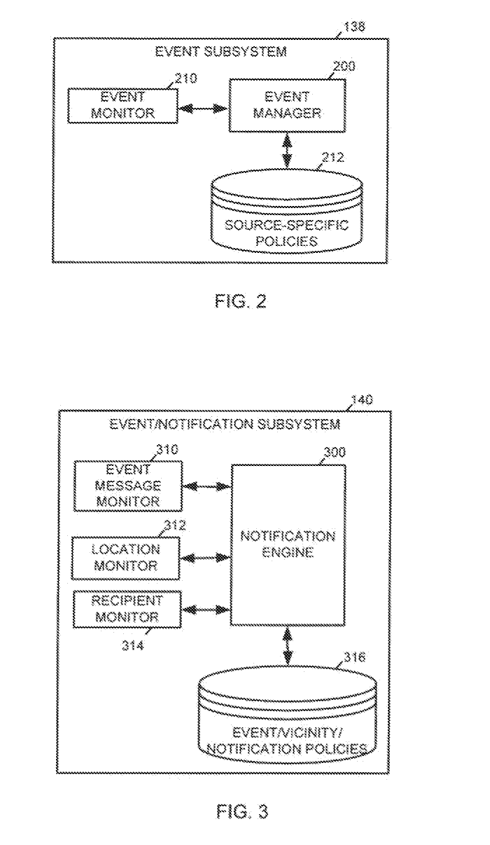

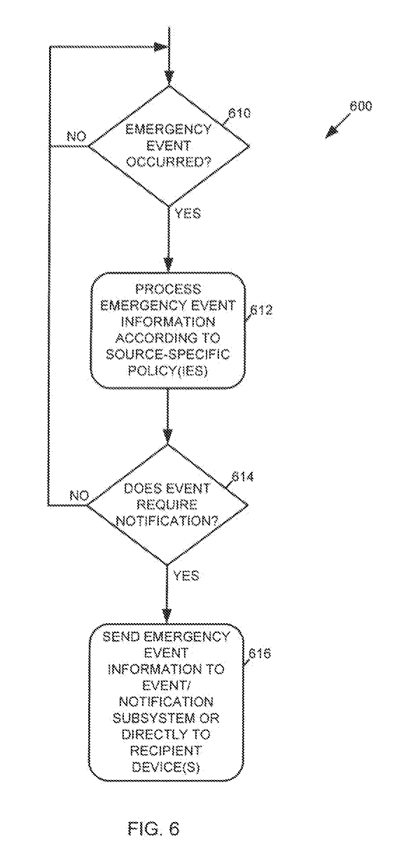

The illustrative source computing device 110 is operably coupled to the emergency vehicle 102, so that data indicating whether the emergency vehicle 102 is or is not responding to an emergency event can be received by the source computing device 110. The data indicating whether the emergency vehicle 102 is or is not responding to an emergency event may be obtained via one or more sensor(s) 130, which may be embodied as any device or mechanism by which a shift by the emergency vehicle 102 into an emergency response mode can be detected. For example, sensor(s) 130 may be embodied as a switch or other sensor located on or coupled to the siren, warning lights, transmission, gearbox, or shift selector of the emergency vehicle 102, or other suitable location in the emergency vehicle 102. In any event, the sensor(s) 130 provide an indication (e.g. by voltage output or a lack of voltage output, for example) in response to the emergency vehicle 102 shifting into an emergency response mode. The illustrative event subsystem 138 processes the emergency event signals generated by the sensor(s) 130, and communication circuitry 134 communicates emergency event information to the network 116 for receipt by the server 112 and/or one or more recipient computing device(s) 114. Aspects of the event subsystem 138 are described in more detail below with reference to FIGS. 2 and 6.

The illustrative source computing device 110 includes at least one processor 120, memory 124, an input/output (I/O) subsystem 126, and at least one data storage device 128. In the in-vehicle computing platform context of the illustrative embodiment, the source computing device 110 is embodied as an embedded system that is installed in the emergency vehicle 102. However, the source computing device 110 may be embodied as any suitable type of computing device that can be associated with an emergency vehicle 102, determine location, direction of travel, and/or other information about the emergency vehicle 102 while the emergency vehicle is in operation, and can be connected to a communication network, such as, for example, a smartphone, laptop or tablet computer system, a handheld computing device, or other electronic device, depending on the requirements of a particular design or implementation.

The illustrative processor 120 includes at least one processor core 122. In addition to an amount of cache memory, the processor 120 includes, or is otherwise communicatively coupled to, the memory 124. The memory 124 may be embodied as any type of suitable memory device, such as a dynamic random access memory device (DRAM), synchronous dynamic random access memory device (SDRAM), double-data rate dynamic random access memory device (DDR SDRAM), and/or other volatile memory device.

The processor 120 is also communicatively coupled to the I/O subsystem 126. While not specifically shown, the illustrative I/O subsystem 126 may include a memory controller (e.g., a memory controller hub (MCH) or northbridge), an input/output controller (e.g., an input/output controller hub (ICH) or southbridge), and a firmware device. Of course, in other embodiments, I/O subsystems having other configurations may be used. For example, in some embodiments, the I/O subsystem 126 may form a portion of a system-on-a-chip (SoC) and be incorporated, along with the processor 120 and other components of the source computing device 110, on a single integrated circuit chip. As such, it will be appreciated that each component of the I/O subsystem 126 may be located on a common integrated circuit chip in some embodiments.

The I/O subsystem 126 is communicatively coupled to the sensor(s) 130, a navigation system 132, the communication circuitry 134, and the data storage device 128. The illustrative navigation system 132 may be integrated into the emergency vehicle 102 (e.g., installed in the vehicle dashboard) or may be embodied as a vehicle accessory removable from the emergency vehicle 102. The navigation system 132 is embodied as software or computerized logic and/or instructions that are configured to monitor the geographic location of the emergency vehicle 102 (e.g., relative to absolute coordinates such as longitude and latitude) and its direction of travel (e.g., relative to an absolute direction such as north, south, east and west), using, for example, a cellular location-based service (LBS) or a global positioning system (GPS). In some embodiments, the navigation system 132 may also be in communication with a control system of the emergency vehicle 102 to obtain data indicating the speed and/or direction at which the emergency vehicle 102 is traveling, or may be in communication with a sensor 130 to determine the vehicle speed and/or direction of travel. Also, in some embodiments, the navigation system 132 may provide or interface with a computerized geographic map service to obtain geographic and/or topographical information relating to the location of the emergency vehicle 102 and/or surrounding areas. Further, in some embodiments, the navigation system 132 may provide or interface with a computerized traffic service to obtain traffic information relating to the location or route of travel of the emergency vehicle 102 and/or surrounding areas.

The communication circuitry 134 of the source computing device 110 may be embodied as one or more devices and/or circuitry configured to enable communications between the computing device 110, the server 112, and/or the recipient computing device 114, via the network 116. The communication circuitry 134 may include one or more wired and/or wireless network interfaces or “cards” to facilitate communications over the wired and/or wireless portions of the network 116.

Portions of the data storage device 128 may be embodied as any suitable device for storing data and/or computer instructions, such as disk storage (e.g. hard disks), a network of physical and/or logical storage devices, and/or others. In the illustrative embodiment, the event subsystem 138 resides in the data storage device 128. Also, portions of the navigation system 132 may reside in the data storage 128. Portions of the event subsystem 138 and/or the navigation system 132 may be copied to the memory 124 during operation, for faster processing or other reasons.

The I/O subsystem 126 may be communicatively coupled to one or more peripheral device(s) 136 such as a display, touchpad, keypad, microphone, speaker, and/or others, depending upon, for example, the intended use of the source computing device 110. Further, it should be appreciated that the source computing device 110 may include other components, sub-components, and devices not illustrated in FIG. 1 for clarity of the description.

The illustrative recipient computing device 114 is operably coupled to the non-emergency vehicle 104, in some embodiments (for instance, as part of an in-vehicle information and/or entertainment system, as mentioned above). The recipient computing device 114 includes at least one processor 150, memory 154, an input/output (I/O) subsystem 156, and at least one data storage device 158. In the in-vehicle embodiments, the recipient computing device 114 is embodied as an embedded system that is installed in the non-emergency vehicle 104. However, the recipient computing device 114 may be embodied as any suitable type of computing device that can be associated with a vehicle, determine location, direction of travel, and/or other information about the vehicle while the vehicle is in operation, and be connected to a communication network; such as, for example, a smartphone, laptop or tablet computer system, a handheld computing device, or other electronic device, depending on the requirements of a particular design or implementation.

The illustrative processor 150 includes at least one processor core 152. In addition to an amount of cache memory, the processor 150 includes, or is otherwise communicatively coupled to, the memory 154. The memory 154 may be embodied as any type of suitable memory device, such as a dynamic random access memory device (DRAM), synchronous dynamic random access memory device (SDRAM), double-data rate dynamic random access memory device (DDR SDRAM), and/or other volatile memory device.

The processor 150 is also communicatively coupled to the I/O subsystem 156. While not specifically shown, the illustrative I/O subsystem 156 may include a memory controller (e.g., a memory controller hub (MCH) or northbridge), an input/output controller (e.g., an input/output controller hub (ICH) or southbridge), and a firmware device. Of course, in other embodiments, I/O subsystems having other configurations may be used. For example, in some embodiments, the I/O subsystem 156 may form a portion of a system-on-a-chip (SoC) and be incorporated, along with the processor 150 and other components of the recipient computing device 114, on a single integrated circuit chip. As such, it will be appreciated that each component of the I/O subsystem 156 may be located on a common integrated circuit chip in some embodiments.

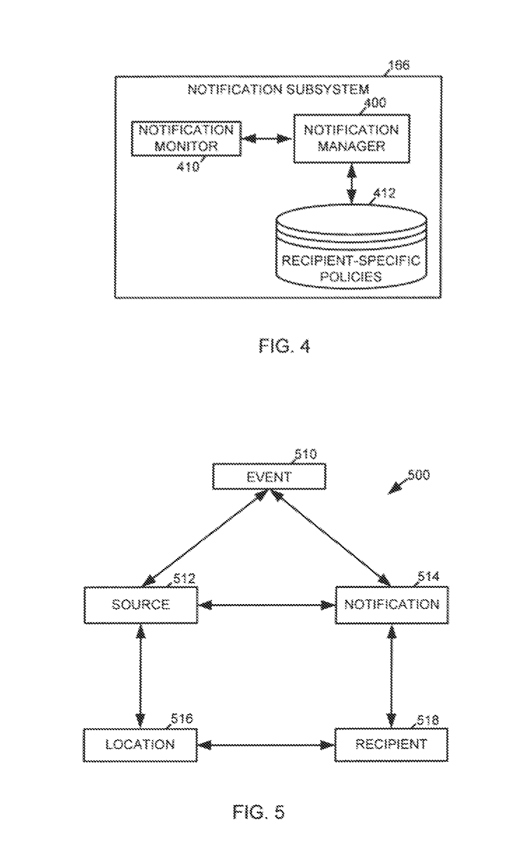

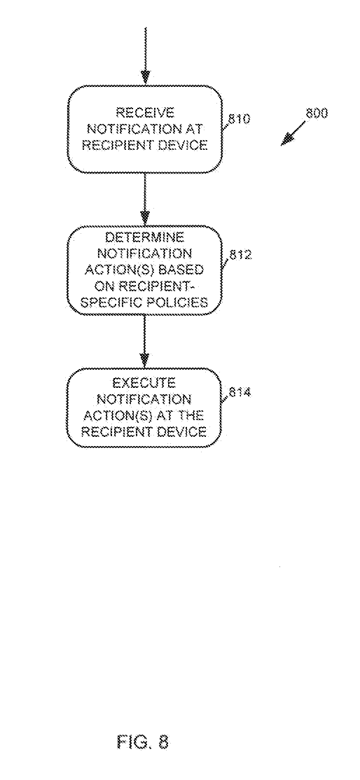

The illustrative I/O subsystem 156 is communicatively coupled to one or more sensor(s) 168, a navigation system 160, communication circuitry 162, and data storage 158. The speed of travel, direction of travel, and/or other information about the non-emergency vehicle 104 may be obtained via the sensor(s) 168, which may be embodied as any device or mechanism by which vehicle speed, direction of travel, and/or other parameters, as the case may be, can be detected. For example, the sensor(s) 168 may be embodied as a switch or other sensor located on or coupled to the engine or motor, transmission, or shift selector of the non-emergency vehicle 104, or other suitable location in the non-emergency vehicle 104. In any event, the sensor(s) 168 can provide an indication (e.g., by voltage output or a lack of voltage output) of the speed of travel, direction of travel, and/or other parameters, as the case may be. In some embodiments, the notification subsystem 166 processes the speed of travel, direction of travel, and/or other parameters generated by the sensor(s) 168, and compares that information to corresponding information generated by the source computing device 110. In other embodiments, the communication circuitry 162 communicates the location, speed of travel, direction of travel, and/or other information to the network 116 for receipt by the server 112, and the server 112 performs the comparison. Aspects of the notification subsystem 166 are described in more detail below with reference to FIGS. 4 and 8.

The illustrative navigation system 160 may be integrated into the non-emergency vehicle 104 (e.g., installed in the vehicle dashboard) or may be embodied as a vehicle accessory removable from the non-emergency vehicle 104. The navigation system 160 is embodied as software and/or computerized instructions that are configured to monitor the geographic location of the non-emergency vehicle 104 (e.g., relative to absolute coordinates such as longitude and latitude) and its direction of travel (e.g., relative to an absolute direction such as north, south, east and west), using, for example, a cellular location-based service (LBS) or a global positioning system (GPS). In some embodiments, the navigation system 160 may also be in communication with a control system of the non-emergency vehicle 104 to obtain data indicating the speed and/or direction at which the non-emergency vehicle 104 is traveling, or may be in communication with a sensor 168 to determine the vehicle speed and/or direction of travel. Also, in some embodiments, the navigation system 160 may provide or interface with a computerized geographic map service to obtain geographic and/or topographical information relating to the location of the non-emergency vehicle 104 and/or surrounding areas. Further, in some embodiments, the navigation system 160 may provide or interface with a computerized traffic service to obtain traffic information relating to the location or route of travel of the non-emergency vehicle 104 and/or surrounding areas.

In operation, power to the navigation system 160 is typically supplied at the same time as the recipient computing device 114 is turned on; however, this need not be the case. For example, in some embodiments, a user of the recipient computing device 114 may turn the navigation system 160 on or off depending on the particular use of the recipient computing device 114 and/or user preferences.

In some embodiments, the vehicle navigation system 160 (and/or the notification subsystem 166, for that matter) forms part of a larger “in-vehicle infotainment” system, which may provide a number of digital applications that can be used by occupants of a vehicle, for example, rear-seat entertainment, music, location-based services, and external connectivity features such as access to the Internet and/or roadside assistance services.

The communication circuitry 162 of the recipient computing device 114 may be embodied as one or more devices and/or circuitry configured to enable communications between the recipient computing device 114, the server 112, and/or the source computing device 110, via the network 116. The communication circuitry 162 may include one or more wired and/or wireless network interfaces or “cards” to facilitate communications over the wired and/or wireless portions of the network 116.

Portions of the data storage device 158 may be embodied as any suitable device for storing data and/or computer instructions, such as disk storage (e.g. hard disks), a network of physical and/or logical storage devices, and/or others. In the illustrative embodiment, the notification subsystem 166 resides in the data storage 158. Also, portions of the navigation system 160 may reside in the data storage 158, in some embodiments. Portions of the notification subsystem 166 and/or the navigation system 160 may be copied to the memory 154 during operation, for faster processing or other reasons.

The I/O subsystem 156 may be communicatively coupled to one or more peripheral device(s) 164 such as a display, touchpad, keypad, microphone, speaker, and/or others, depending upon, for example, the intended use of the recipient computing device 114. Further, it should be appreciated that the recipient computing device 114 may include other components, sub-components, and devices not illustrated in FIG. 1 for clarity of the description.

Referring further to FIG. 1, the server 112 may be embodied in or as any type of computing device or network of computing devices capable of performing at least the functions described herein as being performable by a computing device associated with an emergency event notification service and/or a back end event notification application. For example, all or portions of the server 112 may be embodied in or as a desktop computer, an enterprise computer system, a network of computers, an Internet-enabled hosting service, or other electronic device, system, or combination of any of the foregoing, which is capable of facilitating emergency event notifications, as described herein.

An event/notification subsystem 140 resides at the server 112 and is configured to, via communication circuitry 142, facilitate the routing of emergency event notifications from source computing devices 110 to recipient computing devices 114 in some embodiments. The event/notification subsystem 140 is embodied as software and/or computerized instructions that reside in a data storage device and/or memory of the server 112. Aspects of the event/notification subsystem 140 are described in further detail below with reference to FIGS. 3, 5 and 7. While not specifically shown, it should be understood that the illustrative server 112 includes at least one processor, a memory, an input/output (I/O) subsystem, and at least one storage device, and may include one or more peripheral devices, as well as the communication circuitry 142. Generally speaking, such components of the server 112 are similar or analogous to devices with the same name described above.

The network 116 may be embodied as any type of wired and/or wireless telecommunications network. For example, the network 116 may be embodied as or otherwise include one or more public or private cellular networks, telephone, Digital Subscriber Line (DSL) or cable networks, local or wide area networks, publicly available global networks (e.g., the Internet), or any combination thereof. For example, in some embodiments, the network 116 may be embodied as or otherwise include a Global System for Mobile Communications (GSM) cellular network. Additionally, the network 116 may include any number of additional devices as needed to facilitate communication between or among the source computing device 110, the recipient computing device 114, and the server 112, such as routers, switches, intervening computers and/or others. Any suitable communication protocol (e.g., TCP/IP) may be used to effect communication over the network 116, depending on, for example, the particular type or configuration of the network 116.

In general, the components of the source computing device 110, the recipient computing device 114, and the server 112 are communicatively coupled as shown in FIG. 1, by one or more signal paths. Such signal paths may be embodied as any type of wired or wireless signal paths capable of facilitating communication between the respective devices. For example, the signal paths may be embodied as any number of wires, printed circuit board traces, via, bus, point-to-point interconnects, intervening devices, and/or the like. Also, generally speaking, some of the components of the computing devices described above may be incorporated on a motherboard while other components may be communicatively coupled to the motherboard via, for example, a peripheral port.

Referring now to FIG. 2, the illustrative event subsystem 138 is embodied as software or computerized modules (e.g., logic and/or instructions) including an event manager 200, an event monitor 210, and a database of policies 212 that are associated with the source computing device 110. The illustrative event monitor 210 analyzes indications (e.g., electrical signals output by one or more of the sensor(s) 130) that the emergency vehicle 102 has changed its emergency status (e.g., from a non-emergency mode to an emergency mode). If the emergency vehicle 102 has entered an emergency mode (e.g., by turning on its warning lights or siren), the event monitor 210 interfaces with the event manager 200 to initiate processing of the indication signal. The illustrative event manager 200 evaluates the indication signal in accordance with the one or more source-specific polices 212, and determines whether to generate a notification for direct receipt by the recipient computing device 114, or an emergency event message for receipt by the server 112, as the case may be in a particular embodiment. For example, in embodiments where the source computing device 110 is part of an in-vehicle computer system of an emergency vehicle, a policy might be that a notification or emergency event message is always generated if the emergency vehicle's warning lights and/or siren have been turned on for more than a few seconds. In other embodiments where the source computing device 110 is, for example, a mobile computing device carried by a pedestrian who just witnessed an automobile accident, a policy might be that a notification or emergency event message is generated only if the user of the mobile device verifies that the notification or emergency event message should be sent (e.g., to reduce the risk of false alarms or for other reasons). If, based on the applicable policy(ies), the event manager 200 determines that a notification or emergency event message should be sent, then the event manager 200 initiates action by the communication circuitry 134 to send the notification or emergency event message to the network 116 for receipt by the recipient computing device 114 or the server 112, as the case may be.

Referring now to FIG. 3, the illustrative event/notification subsystem 140 is embodied as software or computerized modules (e.g., logic and/or instructions) executable by the server 112, for example, including a notification engine 300, an event message monitor 310, a vicinity monitor 312, a recipient monitor 314, and a database of policies 316 that are associated with emergency events, notifications, and/or vicinities. The illustrative event message monitor 310 detects incoming emergency event messages generated by source computing devices 110 and filters or otherwise processes those messages as needed, according to one or more of the event/vicinity policies 316. For example, in cases where multiple emergency vehicles are generating emergency indication signals (e.g., indications that they have switched to an emergency mode) but are all responding to the same event, or the same emergency vehicle generates multiple indication signals (e.g., separate indications for warning lights and siren), the event manager 200 of the event subsystem 138 may generate multiple, but related, emergency event messages. Upon receiving multiple related emergency event messages, the event message monitor 310 may interface with the notification engine 300 so that only one notification is generated based on the multiple emergency event messages. As another example, the event message monitor 310 may evaluate the emergency event message to determine its source, and then interface with the notification engine 300 to determine an appropriate notification based on one or more of the event/vicinity/notification policies 316. For instance, in some embodiments, the event message monitor 310 may conclude, based on information in the emergency event message, that the emergency event is a traffic accident without injuries (e.g., if the emergency vehicle 102 is a police car and no related messages have been received from an ambulance or fire truck), and report this information to the notification engine 300 for use in determining appropriate content for the notification, an appropriate vicinity, and/or appropriate recipients of the notification.

Other examples of content that may be included in a notification include a suggested driving maneuver to avoid the emergency vehicle 102, such as a suggested route of travel, a suggested speed or change in speed, and/or a suggested direction or change in direction of travel. Suggested directions or changes in direction of travel may be determined relative to the direction of travel of the non-emergency vehicle 104 or with reference to an absolute direction (e.g., north, south, east, west, etc.). Also, in some embodiments, notifications may be generated based on a distance between the emergency vehicle 102 and the non-emergency vehicle 104 (where the distance may determined by a comparison of the locations of the emergency vehicle 102 and the non-emergency vehicle 104, or by reference to a map service, for example), or by determining an approximate time at which the location of the emergency vehicle and a location of the non-emergency vehicle may coincide or intersect (where the approximate time may be determined by comparing the location, direction of travel, and speed of travel of the vehicles 102, 104, respectively, or by referring to a map service, for example). Further, notifications and/or the content of the notifications may be updated as the location, direction of travel, and/or speed of travel of the vehicles 102, 104, respectively, changes.

The vicinity monitor 312 can be used to determine or customize the vicinity relative to the location of the source computing device 110, in which notifications are to be made available for receipt by recipient computing devices 114, based on one or more of the event/vicinity/notification policies 316. For example, the vicinity (e.g., a geographic area around or adjacent to the location of the source computing device 110 at a particular moment in time) for a particular notification may change based on the type of emergency event that has occurred, the speed or direction of travel of the emergency vehicle 102, and/or other factors. For instance, in some embodiments, the vicinity may include a larger area if the emergency vehicle 102 is traveling at a fast rate of speed or is located on a heavily traveled road (such as a freeway). As another example, in some embodiments, the vicinity may include a larger area if the emergency event is a weather-related event or act of terrorism, and may include a smaller area if the emergency event is crime-related or a traffic accident without injuries.

Alternatively or in addition to the vicinity monitor 312, the recipient monitor 314 can be used to determine the particular recipient computing devices 114 to target with a notification. The illustrative recipient monitor 314 monitors the location, speed of travel, direction of travel, and/or other information relating to recipient computing devices 114, which are received by the server 112 via the communication circuitry 142. The recipient monitor 314 interfaces with the notification engine 300 to select recipient computing devices 114 to receive particular notifications. As an example, recipient computing devices 114 that are within a vicinity of the source computing device 110 that are traveling at a faster speed or in a different direction may receive a different notification (e.g., recipient computing devices 114 that are traveling away from the location of the emergency vehicle 102 may receive a notification but no instruction for getting out of the way of the emergency vehicle 102, while recipient computing devices 114 that are determined to be traveling toward the location of the emergency vehicle may receive a notification with an instruction to move to the right side of the road. As another example, the recipient monitor 314 may interface with the notification engine 300 to select one or more recipient computing devices 114 to receive a notification prior to sending any notifications to other recipient computing devices 114. As a further example, the recipient monitor 314 may interface with the notification engine 300 to select one or more recipient computing devices 114 to receive a notification based on information about the recipient computing device 114. For instance, a recipient computing device 114 that is determined to be part of an in-vehicle computer system may be assigned a higher priority to receive notifications than a recipient computing device 114 that is a handheld device (e.g., to allow the vehicle more time to take action in response to the notification, if necessary). Once the content of the notification and the applicable vicinity and/or recipient devices have been determined, the notification engine 300 utilizes the communication circuitry 142 to send the notification to the network(s) for receipt by the server 112 or the recipient computing device 114.

Referring now to FIG. 4, the illustrative notification subsystem 166 is embodied as software or computerized modules (e.g., logic and/or instructions) including a notification manager 400, a notification monitor 410, and a database of policies 412 that are associated with the recipient computing device 114. The illustrative notification monitor 410 detects incoming notifications generated by the server 112 or the source computing device 110, as the case may be, and filters or otherwise processes those notifications as needed, according to one or more policies 412 relating to the recipient computing device 114. The illustrative notification manager 400 effectuates the notification, including any embedded instructions or suggestions, at the recipient computing device 114. For example, if the recipient computing device 114 is embodied as an in-vehicle computer system, the notification manager 400 may mute or lower the volume of any media that are playing in the non-emergency vehicle 104 (such as music or video) prior to issuing an audible notification. As another example, in some embodiments, the notification manager 400 may display a visual notification at a dashboard display screen of the in-vehicle computer system.

In embodiments where the recipient computing device 114 is a mobile computing device typically carried by a person, the notification manager 400 may “wake up” the recipient computing device 114 if it is “asleep” (e.g., in a power-saving mode) or automatically turn on the locating service or navigation system of the recipient computing device 114 if it has been turned off, or take other action to control a feature of the recipient computing device 114, in response to a notification. The notification manager 400 may issue updated instructions as the location, direction of travel, or speed of travel of the emergency vehicle 102 or the non-emergency vehicle 104 changes, or based on an updated comparison of the location, direction of travel, or speed of travel of the vehicles 102, 104, respectively. In other words, in at least some embodiments, the event notification system 100 continues to monitor and compare the location, direction of travel, and/or speed of travel of an emergency vehicle 102 that is operating in an emergency mode to the location, direction of travel, and/or speed of travel of non-emergency vehicles 104, even after a notification is generated, until the emergency vehicle 102 is no longer operating in an emergency mode or is out of range of the non-emergency vehicles 104.

Referring now to FIG. 5, an illustrative data model 500 for portions of the emergency event notification system 100 is embodied as event 510, source 512, notification 514, vicinity 516, and recipient 518 data objects. In general, the double-headed arrows connecting the various data objects as shown in FIG. 5 indicate many-to-many relationships or associations among the data objects, although one-to-one and/or one-to-many relationships are also possible in some embodiments. For example, an emergency event 510 may be detected by many different sources 512 (e.g., a source computing device 110), and a source 512 may detect many different emergency events 510. Similarly, multiple notifications 514 may be associated with a single emergency event 510 and each notification 514 may be associated with a number of emergency events 510 (as in the case where an event 510 is reported differently by different sources 512). Likewise, both sources 512 and recipients 518 may be associated with multiple vicinities (e.g., as their location changes, they may enter a new vicinity), while each vicinity may have multiple sources 512 and recipients 518 associated therewith. To implement the policies 212, 316, 412, each data object 510, 512, 514, 516, 518 may include at least one field or data store for storing policy information (e.g., rules and/or preference information). The illustrative data model 500 may be embodied as one or more databases, look-up tables, files, or other data structures. Also, portions of the data model 500 may be stored in memory at the associated computing devices 110, 112, 114 and/or other computing devices as may be appropriate or desired according to a given design or implementation of the emergency event notification system 100.

Referring now to FIG. 6, an illustrative method 600 executable as computerized logic and/or instructions by the event subsystem 138 at the source computing device 110, for example, is shown. At block 610, the method 600 continuously monitors inputs received by the source computing device 110 and determines whether an emergency event has occurred (e.g., based on signals received from one or more of the sensor(s) 130, information provided by the navigation system 132, input from a user, and/or other sources, as described above). In the illustrative embodiment, the monitoring continues until an emergency event occurs or the system is powered off. In response to an emergency event, at block 612, the emergency event information (e.g., indication signals from an emergency vehicle, input from a user or sensor, and/or others) is processed according to the source-specific policies 212 as described above to determine whether a notification of the emergency event should be generated. If it is determined at block 614 that a notification should be generated, then at block 616, the notification is generated for receipt by recipient computing devices 114. In some embodiments, the notification is generated by the event subsystem 138 at the source computing device 110 and sent to the network 116 for receipt by one or more of the recipient computing devices 114. In other embodiments, the emergency event information is sent by the source computing device 110 over the network 116 to the server 112 for analysis by the notification engine 300, which determines whether to generate a notification in response to the emergency event information and sends notifications to the network 116 for receipt by one or more of the recipient computing devices 114.

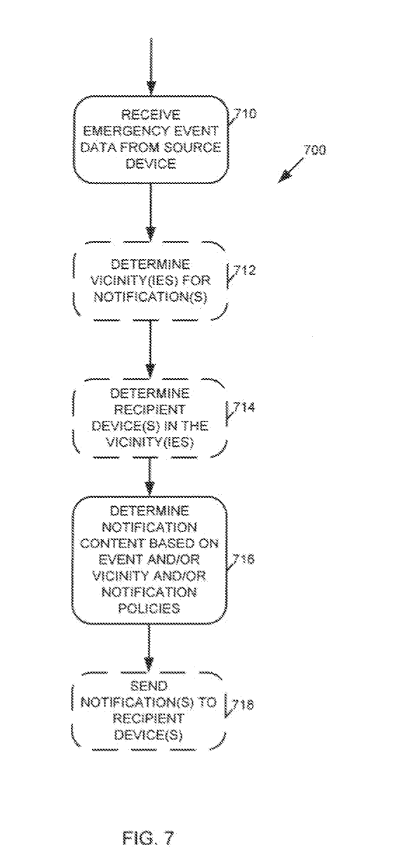

Referring now to FIG. 7, an illustrative method 700 executable as computerized logic and/or instructions by the server 112 or the recipient computing device 114, for example, is shown. At block 710, the emergency event data generated by the source computing device 110 is received at the server 112 or the recipient computing device 114, as the case may be according to particular embodiments. Blocks 712 and 714 are applicable to embodiments in which the method 700 is executed by the server 112. For example, the server 112 may receive multiple emergency event messages from different source computing devices 110 and may receive location, direction of travel, speed of travel and/or other location-related information from multiple source computing devices 110 and multiple recipient computing devices 114. At block 712, emergency event data and source computing device 110 location data are resolved to determine one or more vicinities in which it may be desirable to notify recipient computing devices 114 of the emergency event. For example, as mentioned above, a vicinity may be defined as an area surrounding or adjacent to a location of the source computing device 110 and within a certain range (measured in, e.g., meters, miles, kilometers, etc.) of the location of the source computing device, where the range may be determined based on the type of emergency event that has occurred and/or other factors. Also as mentioned above, multiple vicinities may be defined for a single emergency event, so that notifications can be customized for recipient computing devices 114 according to vicinity.

At block 714, the method 700 may identify recipient computing devices 114 that are located in each of the vicinity(ies) defined at block 712, based on the location, direction of travel, speed of travel, and/or other information related to the location of the recipient computing device 114 that is continuously or periodically uploaded to the server 112 via the communication circuitry 162 of the recipient computing device 114. In some embodiments, the location, direction of travel, speed of travel and/or other location-related information of the recipient computing device 114 is simply compared to the corresponding information of the source computing device 110. However, in other embodiments as noted above, the location-related information of the recipient computing device 114 is compared to one or more of the vicinities determined at block 712. At block 716, the content of the notification is determined based on one or more of the policies 316 as described above. For example, some notifications may simply include an alert (e.g., an audible or visual indicator, message, or graphic) while other notifications may include one or more instructions, such as a suggested driving maneuver (e.g., “pull over to the right side of the road,” or “emergency vehicle is heading in the opposite direction, no action needed”), alternatively or in addition to an alert. The instructions may be output in audible (e.g., at a speaker of the recipient computing device 114) or visual (e.g., at a display of the recipient computing device 114) form as may be required or desirable according to a given design of the recipient computing device 114 and/or other factors. Block 718 is applicable to embodiments in which the method 700 is executed by the server 112. At block 718, the server 112 sends the notifications to the network 116 for receipt by the recipient computing devices 114 in each vicinity. In some embodiments, notifications may be sent, by either the source computing device 110 or the server 112, using a “broadcast” method in which the notification is not directed to a particular recipient computing device 114 but can be received by all such devices in the defined vicinity. In other embodiments, notifications may be directed to specific recipient computing devices 114 based on location-related information uploaded to the server 112 by the recipient computing devices 114. As should be understood, the location-related information can be associated with a particular recipient computing device 114 (or a particular source computing device 110, for that matter) via a unique device identifier, such as an International Mobile Equipment Identity (IMEI) and/or others. References herein to “sending notifications,” “generating notifications for receipt by,” and/or similar language are intended to encompass any suitable communication technique, whether broadcast, direct transmission, or otherwise.

Referring now to FIG. 8, an illustrative method 800 executable as computerized logic and/or instructions by the recipient computing device 114, for example, is shown. At block 810, a notification of an emergency event is received at a recipient computing device 114. At block 812, the method 800 determines how the notification should be effectuated at the recipient computing device 114 (e.g., with or without exerting control over a feature of the recipient computing device 114, with or without issuing an instruction), according to the recipient-specific policies 412 as described above. For example, in some embodiments where the recipient computing device 114 is coupled to an in-vehicle computer system, an audible notification may only be generated when the in-vehicle computer system determines that the vehicle is in use (e.g., to avoid unnecessary notifications). At block 814, the notification action(s) determined at block 812 are executed at the recipient computing device 114.

### EXAMPLES

Illustrative examples of the devices, systems, and methods disclosed herein are provided below. An embodiment of the devices, systems, and methods may include any one or more, and any combination of, the examples described below.

In one example, a computing device may be configured to facilitate a response to an emergency event, and may include a notification monitor configured to receive at least one notification relating to an emergency event detected by a second computing device, the at least one notification based on at least one of a location, direction of travel, and speed of travel of the second computing device; and a notification manager in communication with the notification monitor and configured to alter an operational state of the computing device in response to receiving the at least one notification.

In an example, the computing device may be located in a non-emergency vehicle, comprises an in-vehicle computer system, and the notification manager may be configured to output, in the non-emergency vehicle, information relating to the at least one notification. In an example, the computing device may be configured to be carried by a person. In an example, the computing device may include at least one audio output, and the notification manager may be configured to adjust the volume of the at least one audio output in response to the at least one notification. In an example, the computing device may include a navigation system, and the notification manager may be configured to automatically turn on the navigation system in response to receiving the at least one notification relating to an emergency event. In an example, the computing device may include a power management system that may be configured to place the computing device into a power-saving mode, and the notification manager may be configured to automatically take the computing device out of the power-saving mode in response to receiving the at least one notification relating to an emergency event. In an example, the notification manager may be configured to alter the operational state of the computing device based on at least one of the at least one notification relating to an emergency event and device-specific information associated with the computing device.

In another example, a system for providing emergency event notifications may include a third computing device configured to receive, from a first computing device associated with an emergency vehicle, an indication that an emergency event has occurred and a location and direction of travel of the emergency vehicle, the third computing device configured to compare the location and direction of travel of the emergency vehicle to a location and direction of travel of at least one second computing device not associated with the emergency vehicle, and, based on the comparison of the location and direction of travel of the first mobile computing device to the location and direction of travel of the at least one second mobile computing device, generate at least one instruction relating to the emergency event for annunciation at the at least one second mobile computing device, and send the at least one instruction to the at least one second mobile computing device.

In an example, the third computing device may be configured to continuously compare the location and direction of travel of the emergency vehicle to the location and direction of travel of the at least one second computing device not associated with the emergency vehicle while the emergency vehicle is in use, and update the at least one instruction in response to the continuous comparing. In an example, the third computing device may be configured to generate at least one suggested route of travel for the at least one second computing device based on the comparison of the location and direction of travel of the emergency vehicle to the location and direction of travel of the at least one second computing device. In an example, the third computing device may be configured select a second computing device to receive the at least one instruction based on at least one of the location and direction of travel of the at least one second computing device. In an example, the third computing device may be configured to select a second computing device to receive the at least one instruction based on device-specific information associated with the at least one second computing device. In an example, the third computing device may be configured to send the at least one instruction to the selected second mobile computing device prior to sending any instructions to other second computing devices. In an example, the third computing device may be configured to determine the at least one instruction based on at least one of a speed of travel of the emergency vehicle, a speed of travel of the at least one second computing device, a distance between the emergency vehicle and the at least one second computing device, and an approximate time at which the emergency vehicle and the at least one second computing device may be at a common location.

In another example, a method for providing emergency event notifications may include, at an in-vehicle computing device located in a non-emergency vehicle: receiving at least one of location, speed, and direction of travel relating to an emergency vehicle that is in use; and in response to the receiving, generating a notification audible in the non-emergency vehicle. The notification may be configured based on at least one of the location, speed, and direction of travel of the emergency vehicle.

In an example, the method may include, at the in-vehicle computing device located in the non-emergency vehicle, comparing at least one of a location, speed, and direction of travel of the non-emergency vehicle to the location, speed, or direction of travel, respectively, of the emergency vehicle, formulating an instruction based on the comparing, and including the instruction in the audible notification. In an example, the instruction may include a suggested driving maneuver to avoid the emergency vehicle. In an example, the suggested driving maneuver may include at least one of a suggested route, a suggested speed, and a suggested direction of travel. In an example, the suggested direction of travel may be determined relative to the direction of travel of the non-emergency vehicle. In an example, the suggested direction of travel may be determined with reference to an absolute direction. In an example, the audible notification may include an indication that no action is required in response to the information received from the emergency vehicle.

In another example, the method may include, at the in-vehicle computing device located in the non-emergency vehicle, comparing a first location, speed, or direction of travel of the non-emergency vehicle to a first location, speed, or direction of travel, respectively, of the emergency vehicle, formulating a first instruction based on the first comparing, including the first instruction in the audible notification, comparing a second location, speed, or direction of travel of the non-emergency vehicle to a second location, speed, or direction of travel, respectively, of the emergency vehicle, formulating a second instruction based on the second comparing, and generating a second notification audible in the non-emergency vehicle, the notification including the second instruction.

In an example, the method may include controlling a user-controllable feature of the in-vehicle computing device prior to generating the audible notification. In an example, the method may include lowering the volume of any audio feature(s) of the in-vehicle computing device that are in use prior to generating the audible notification. In an example, the method may include activating a navigation system of the in-vehicle computing device in response to receiving the information relating to the emergency vehicle that is in use. In an example, the method may include determining whether the non-emergency vehicle is in use and generating the audible notification only in response to the non-emergency vehicle being in use. In an example, the method may include determining a distance between the emergency vehicle and the non-emergency vehicle and configuring the at least one notification based on the distance between the emergency vehicle and the non-emergency vehicle. The method may include determining an approximate time at which the location of the emergency vehicle and a location of the non-emergency vehicle may intersect, and configuring the at least one notification based on the approximate time at which the location of the emergency vehicle and the location of the non-emergency vehicle may intersect.

In another example, a computing device may be configured to provide emergency event notifications, and may include at least one processor; and computer circuitry coupled to the at least one processor, the computer circuitry being arranged to cause the at least one processor to perform any of the foregoing methods. In another example, at least one computer accessible medium may be configured to provide emergency event notifications, and may include a plurality of instructions that in response to being executed result in a computing device performing any of the foregoing methods.

In another example, a method for providing emergency event notifications, may include at an in-vehicle computing device located in an emergency vehicle, in response to the emergency vehicle being in use: generating a signal indicating at least one of location, speed, direction of travel, and emergency status information relating to the emergency vehicle, the signal configured to activate an emergency vehicle notification system of an in-vehicle computing device of a non-emergency vehicle that is in use and located in a vicinity defined by at least one of the location, speed, and direction of travel of the emergency vehicle. In an example, the method may include restricting the information indicated by the signal in accordance with at least one policy associated with the emergency vehicle. In an example, the method may include sending the signal over a network for receipt by the in-vehicle computing device of the non-emergency vehicle. In an example, the method may include generating a second signal indicating at least one second location, speed, direction of travel, or emergency status of the emergency vehicle, and sending the second signal over the network for receipt by an in-vehicle computing device of a non-emergency vehicle that is in use and located in a vicinity defined by at least one of the second location, speed, and direction of travel of the emergency vehicle.

In another example, a computing device may be configured to provide emergency event notifications, and may include at least one processor; and computer circuitry coupled to the at least one processor, where the computer circuitry is arranged to cause the at least one processor to perform any of the foregoing methods. In an example, at least one computer accessible medium may be configured to provide emergency event notifications, and may include a plurality of instructions that in response to being executed result in a computing device performing any of the foregoing methods.

In another example, a method for facilitating a response to an emergency event may include, at a third computing device: receiving, from a first computing device associated with an emergency vehicle, an indication that an emergency event has occurred, and a location and a direction of travel of the emergency vehicle; receiving, from a second computing device not associated with the emergency vehicle, a location and a direction of travel of the second computing device; comparing the location and direction of travel of the emergency vehicle to the location and direction of travel of the second computing device; determining a travel-related instruction to send to the second computing device based on the comparison of the location and direction of travel of the first computing device to the location and direction of travel of the second computing device; and sending the travel-related instruction to the second computing device.

In an example, the first computing device may include a computer system mounted in the emergency vehicle, and the method may include, at the third computing device, receiving the indication that an emergency event has occurred from the emergency vehicle computer system. In an example, the second computing device may be mounted in a non-emergency vehicle and comprises an in-vehicle computer system. In an example, the second computing device may be configured to be carried by a person. In an example, the method may include determining the travel-related instruction based on the indication of the emergency event. In an example, the method may include, at the third computing device, identifying a plurality of second computing devices not associated with the emergency vehicle, selecting less than all of the plurality of second computing devices, and sending the at least one notification to only the selected second computing device(s).

In another example, a computing device may be configured to facilitate a response to an emergency event, and may include at least one processor and computer circuitry coupled to the at least one processor, where the computer circuitry may be arranged to cause the at least one processor to perform any of the foregoing methods. In another example, at least one computer accessible medium may be configured to facilitate a response to an emergency event, and may include a plurality of instructions that in response to being executed result in a computing device performing any of the foregoing methods.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the present disclosure are desired to be protected. For example, it should be appreciated that the term “mobile computing device” as used herein can refer to computing devices that can be carried by a person as well as computing devices that are otherwise mobile. For example, in-vehicle computer systems may be considered “mobile” insofar as they may be embodied in a mobile apparatus (e.g., a vehicle). Further, while aspects of the present disclosure have been described in the context of an emergency vehicle notification system, it will be understood that the various aspects have other applications, for example, any application in which it is desired to notify a mobile computing device of an emergency event and/or send customized suggestions or instructions to a mobile computing device based on the proximity of the mobile computing device to the emergency event. Such applications may include, for example, weather- and/or crime-reporting applications.

1-44. (canceled)

45. A computing device configured to facilitate a response to an emergency event, comprising:
at least one data storage;
at least one processor;
a notification monitor executable by the at least one processor and configured to receive at least one notification relating to an emergency event detected by a second computing device, the at least one notification based on at least one of a location, direction of travel, and speed of travel of the second computing device; and
a notification manager in communication with the notification monitor and configured to alter an operational state of the computing device in response to receiving the at least one notification.

46. The computing device of claim 45, wherein the computing device is located in a non-emergency vehicle, comprises an in-vehicle computer system, and the notification manager is configured to output, in the non-emergency vehicle, information relating to the at least one notification.

47. The computing device of claim 45, wherein the computing device is configured to be carried by a person.

48. The computing device of claim 45, comprising at least one audio output, wherein the notification manager is configured to adjust the volume of the at least one audio output in response to the at least one notification.

49. The computing device of claim 45, comprising a navigation system, wherein the notification manager is configured to automatically turn on the navigation system in response to receiving the at least one notification relating to an emergency event.

50. The computing device of claim 45, comprising a power management system configured to place the computing device into a power-saving mode, wherein the notification manager is configured to automatically take the computing device out of the power-saving mode in response to receiving the at least one notification relating to an emergency event.

51. The computing device of claim 45, wherein the notification manager is configured to alter the operational state of the computing device based on at least one of the at least one notification relating to an emergency event and device-specific information associated with the computing device.

52. A system for providing emergency event notifications, comprising:
a third computing device configured to receive, from a first computing device associated with an emergency vehicle, an indication that an emergency event has occurred and a location and direction of travel of the emergency vehicle, the third computing device configured to compare the location and direction of travel of the emergency vehicle to a location and direction of travel of at least one second computing device not associated with the emergency vehicle, and, based on the comparison of the location and direction of travel of the first mobile computing device to the location and direction of travel of the at least one second mobile computing device, generate at least one instruction relating to the emergency event for annunciation at the at least one second mobile computing device, and send the at least one instruction to the at least one second mobile computing device.

53. The system of claim 52, wherein the third computing device is configured to continuously compare the location and direction of travel of the emergency vehicle to the location and direction of travel of the at least one second computing device not associated with the emergency vehicle while the emergency vehicle is in use, and update the at least one instruction in response to the continuous comparing.

54. The system of claim 52, wherein the third computing device is configured to generate at least one suggested route of travel for the at least one second computing device based on the comparison of the location and direction of travel of the emergency vehicle to the location and direction of travel of the at least one second computing device.

55. The system of claim 52, wherein the third computing device is configured select a second computing device to receive the at least one instruction based on at least one of the location and direction of travel of the at least one second computing device.

56. The system of claim 52, wherein the third computing device is configured to select a second computing device to receive the at least one instruction based on device-specific information associated with the at least one second computing device.

57. The system of claim 56, wherein the third computing device is configured to send the at least one instruction to the selected second mobile computing device prior to sending any instructions to other second computing devices.

58. The system of claim 52, wherein the third computing device is configured to determine the at least one instruction based on at least one of a speed of travel of the emergency vehicle, a speed of travel of the at least one second computing device, a distance between the emergency vehicle and the at least one second computing device, and an approximate time at which the emergency vehicle and the at least one second computing device may be at a common location

59. One or more machine-readable storage media comprising a plurality of instructions stored thereon that, in response to execution by a computing device, cause the computing device to:
receive at least one of location, speed, and direction of travel relating to an emergency vehicle that is in use; and
in response to the receiving, generating a notification audible in the non-emergency vehicle, the notification being configured based on at least one of the location, speed, and direction of travel of the emergency vehicle,
wherein the computing device is an in-vehicle computing device located in a non-emergency vehicle.

60. The one or more machine-readable storage media of claim 59, wherein the plurality of instructions further cause the computing device to compare at least one of a location, speed, and direction of travel of the non-emergency vehicle to the location, speed, or direction of travel, respectively, of the emergency vehicle, to formulate an instruction based on the comparison, and include the instruction in the audible notification.

61. The one or more machine-readable storage media of claim 59, wherein the instruction comprises at least one of a suggested route, a suggested speed, and a suggested direction of travel determined relative to the direction of travel of the non-emergency vehicle.

62. The one or more machine-readable storage media of claim 59, wherein the audible notification comprises an indication that no action is required in response to the information received from the emergency vehicle.

63. The one or more machine-readable storage media of claim 59, wherein the plurality of instructions further cause the computing device to lower the volume of any audio feature(s) of the in-vehicle computing device that are in use prior to generation of the audible notification.

64. The one or more machine-readable storage media of claim 59, wherein the plurality of instructions further cause the computing device to determine whether the non-emergency vehicle is in use and generate the audible notification only in response to the non-emergency vehicle being in use.
